(19) United States
(12) Patent Application Publication
(10) Pub. No.: US 2015/0266104 A1
(43) Pub. Date: Sep. 24, 2015

(54) Energy-Saving and Safer Drill Press

(71) Applicant: Lee-Cheng Chang, Taichung City (TW)

(72) Inventor: Lee-Cheng Chang, Taichung City (TW)

(21) Appl. No.: 14/219,089

(22) Filed: Mar. 19, 2014

(51) Int. Cl. B23B 39/00

(52) U.S. Cl. CPC B23B 39/00; B23B 2260/12; B23B 2260/0482; B23B 2260/122

(57) ABSTRACT

An energy-saving and safer drill press includes a drill head having an original position and being operably moved from the original position in the process of a workpiece. A control selectively engages with the drill head. The drill press has a turned on and turn off modes. The drill press in the turned on mode thereof and the drill head in a position disengaging from the control include the drill head in a spinning motion and spins a bit when the bit is installed to the drill head. The drill press in the turned on mode thereof and the drill head in a position engaging with the control include the drill head in a stop and non-spin motion.

### BACKGROUND OF THE INVENTION

1. Field of the Invention

The present invention relates to a drill press and, particularly to a drill press that is energy-saving and safer.

2. Description of the Related Art

Drill presses are popular machines for both domestic and industrial applications involving the drilling and/or shaping of metal, wood and other types of materials. Generally, a drill press includes a base, a column, a platform, a drill head, and a motor. The drill head is driven by the motor. The motor has a switch control. The switch is turned on when the motor is operating. The switch is turned off when the motor is not operating. During the use of the drill press, the motor drives the drill head and a user thereof lowers a tool bit on the drill head to drill and/or shaping a workpiece. After the workpiece is drilled, the user backs the bit up out of it. For a safety operation of the drill press, the motor will be switched off before drilling and/or shaping another workpiece. However, the user can't work efficiently. It can be hazardous for the user if the drill head is still operating while getting the next workpice on the platform.

The present invention is, therefore, intended to obviate or at least alleviate the problems encountered in the prior art.

### SUMMARY OF THE INVENTION

According to the present invention, an energy-saving and safer drill press includes a drill head having an original position and being operably moved from the original position in the process of a workpiece. A control selectively engages the drill head. The drill press has a turned on and turn off modes. The drill press in the turned on mode thereof and the drill head in a position disengaging from the control include the drill head in a spinning motion and spins a bit when the bit is installed to the drill head. The drill press in the turned on mode thereof and the drill head in a position engaging with the control include the drill head in a stop and non-spin motion.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a drill press that is energy-saving and safer.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of a drill press in accordance with the present invention.

FIG. 2 is a perspective view of the drill press, taken from a view different from FIG. 1.

FIG. 3 is a partial, exploded perspective view of the drill press.

FIG. 4 is a cross-sectional view of the drill press.

FIG. 5 is a continued cross-sectional view of FIG. 4, with a drill head of the drill press in a lower position.

FIG. 6 shows the drill press in the turned on mode thereof, with the drill head engaging with a control.

FIG. 7 shows the drill press in the turned on mode thereof, with the drill head disengaging from the control.

### DETAILED DESCRIPTION OF THE INVENTION

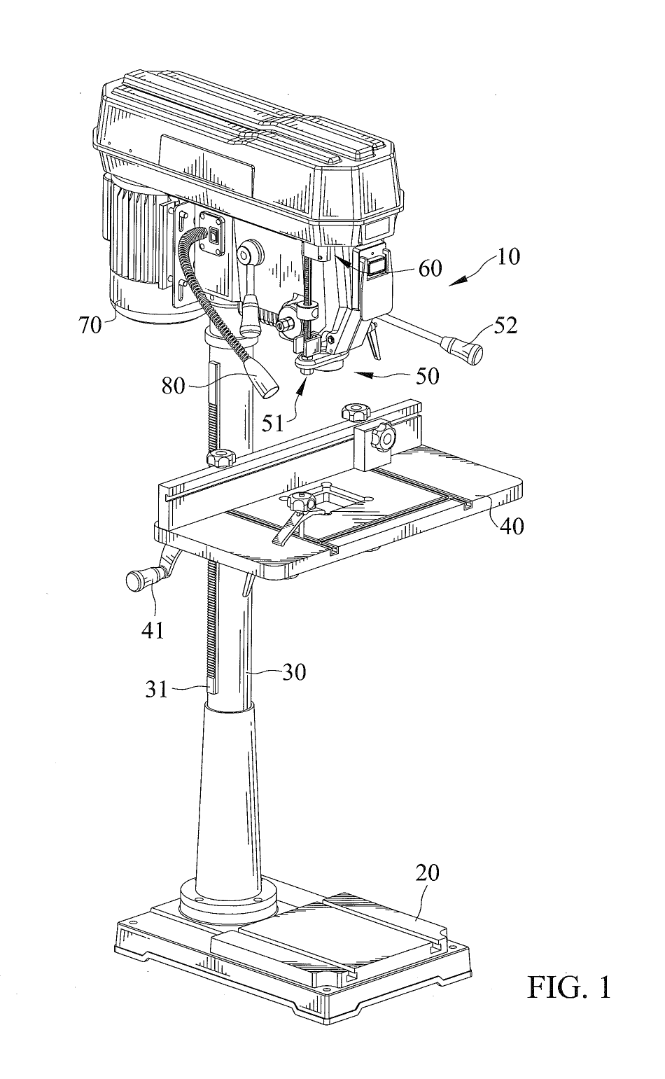

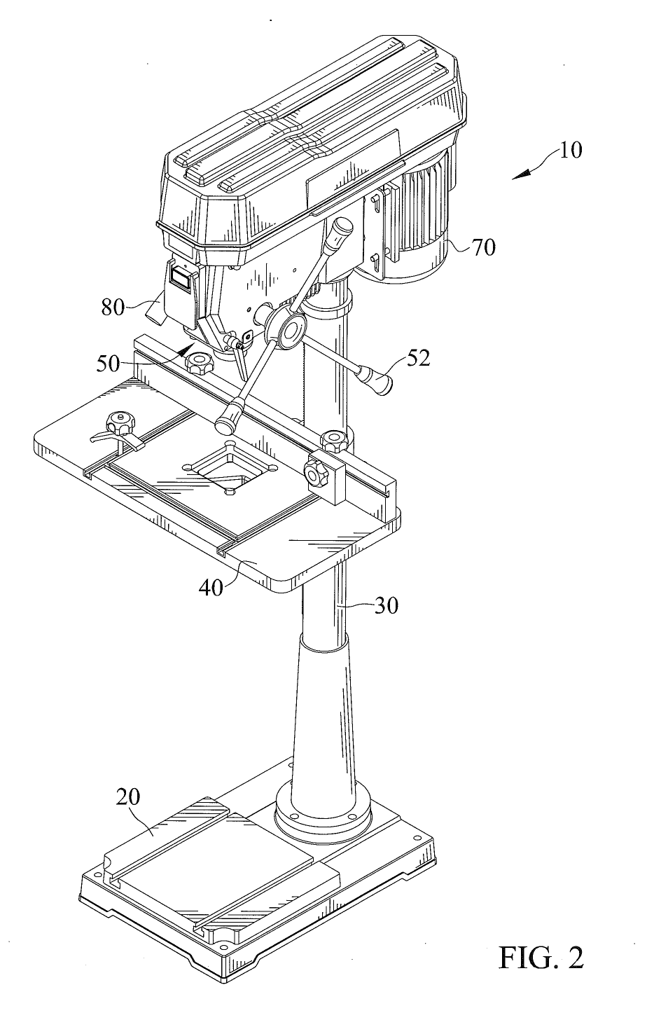

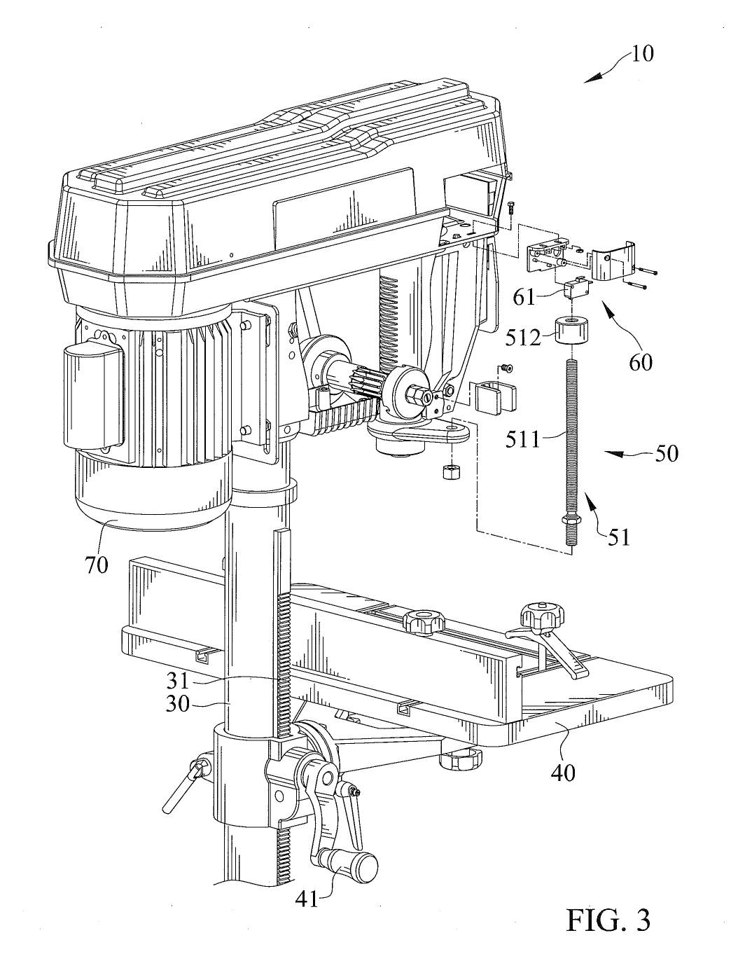

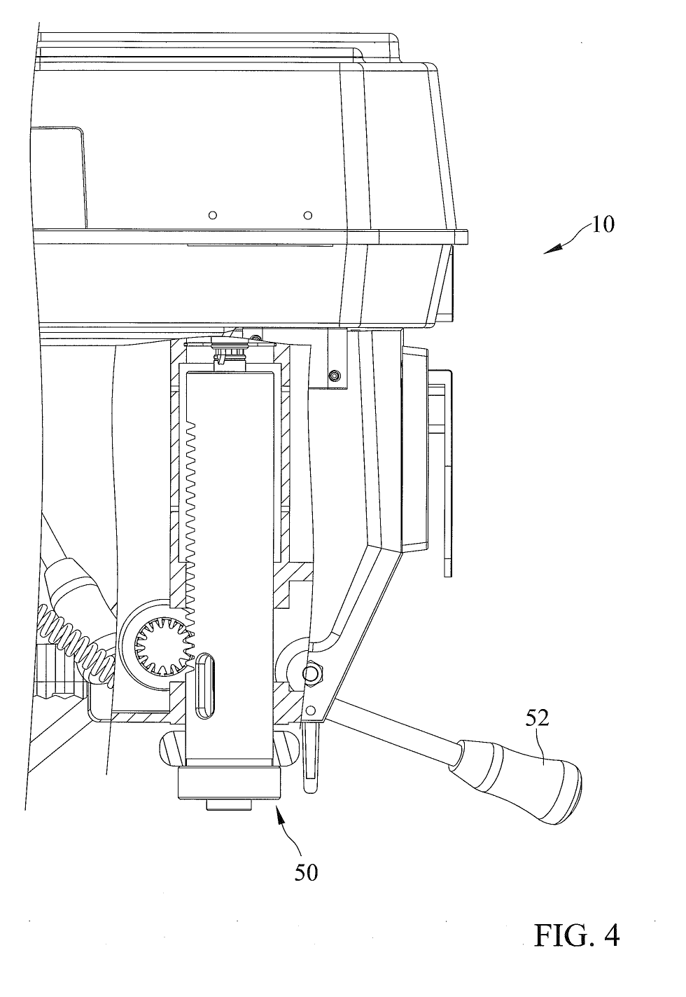

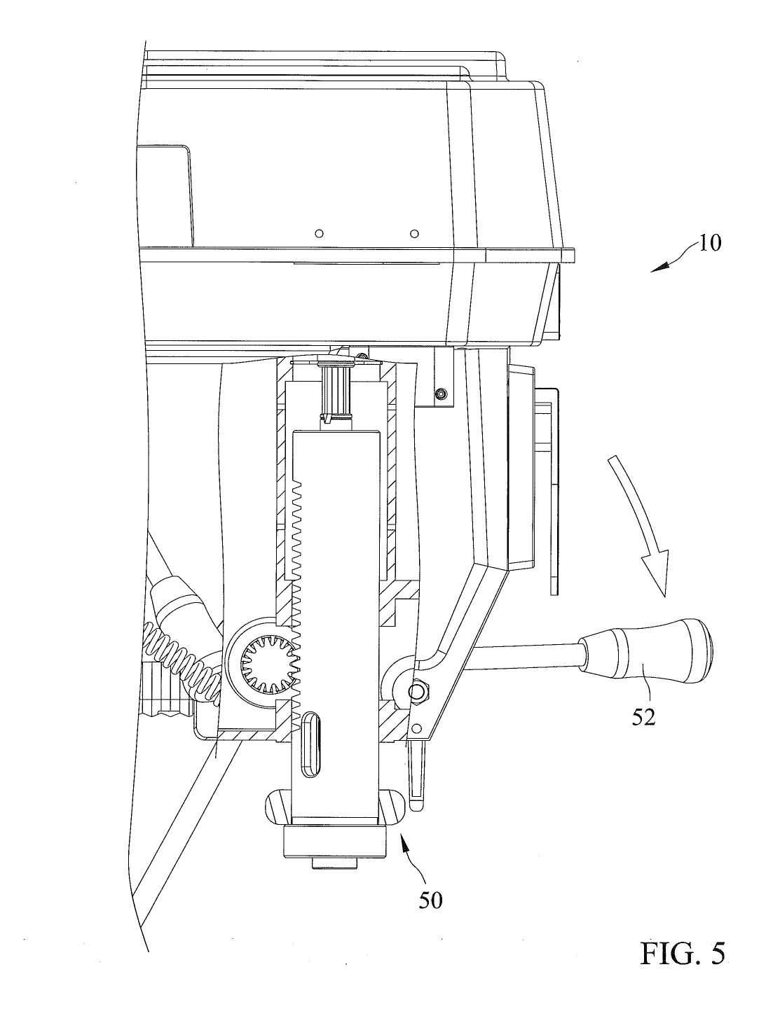

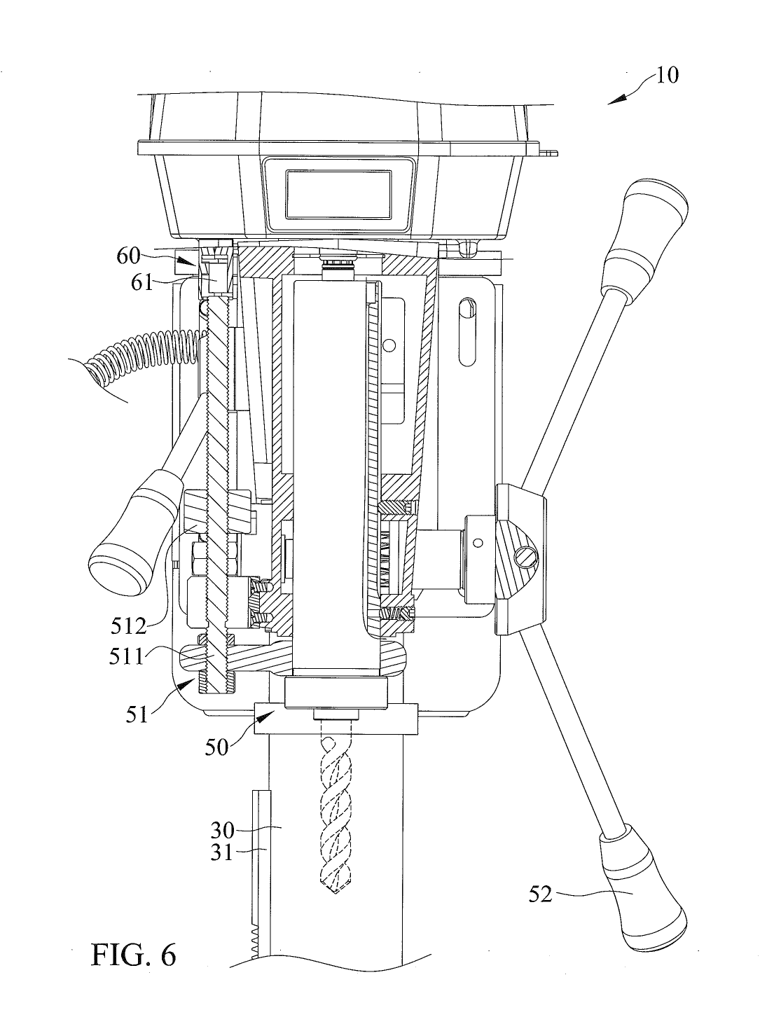

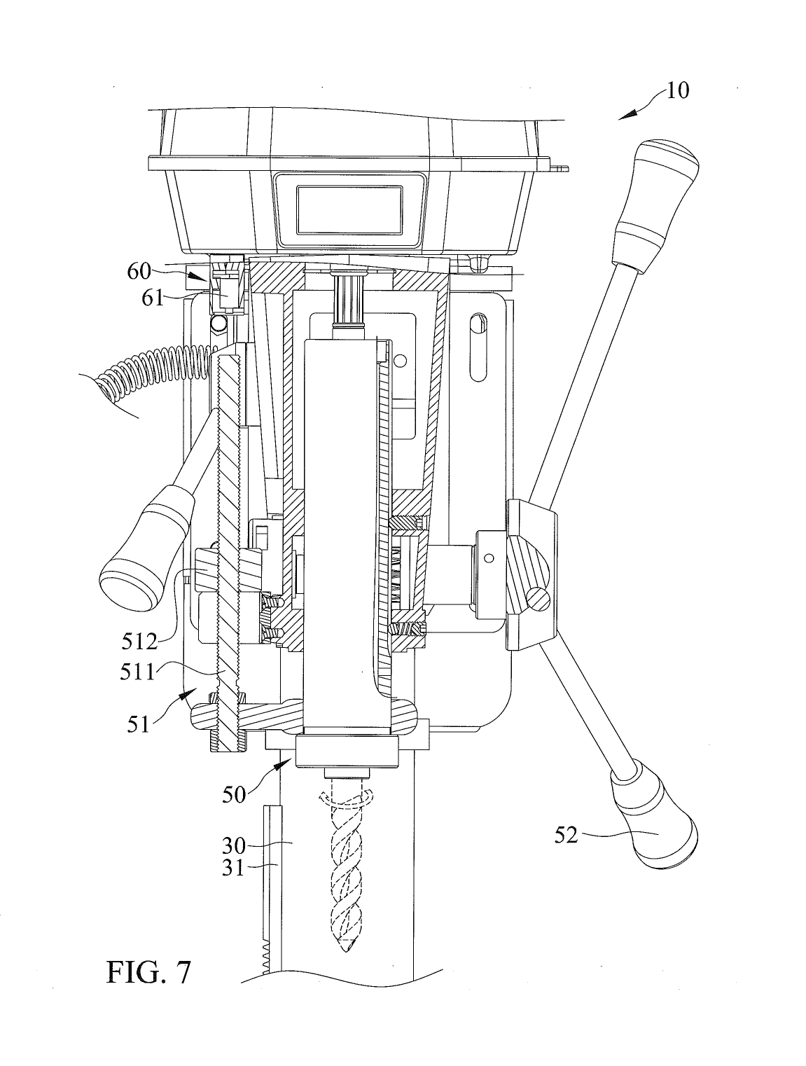

FIGS. 1 through 7 show an energy-saving and safer drill press 10 in accordance with the present invention includes

A drill head 50 has an original position and is operably moved from the original position in the process of a workpiece. The drill head 50 includes a depth adjusting mechanism 51 and a feed handle 52 A user can operate the feed handle 52 to operably move the drill head 50 from the original position.

A control 60 selectively engages with the drill head 50. The control 60 includes a switch 61 and the depth adjusting mechanism 51 that determines an allowable moving distance of the drill head 50 selectively engages with the switch 61. The depth mechanism 51 is equipped with the drill head 50. The depth mechanism 51 includes a rod 511 moving with the drill head 50 and selectively engaging with the switch 61 and includes a stopper 512 adjustably disposed on and moving with the rod 511. The rod 511 and the stopper 512 are threadly engaged with each other. The stopper 512 abuts against a stop structure when the drill head 50 is stopped.

The drill head 50 includes a motor 70 cooperating therewith. The control 60 and the motor 70 are electrically connected with each other. The motor 70 drives the drill head 50 to spin. The drill press 10 in the turned on mode thereof includes the motor 70 transmitting mechanical energy to the drill head 50. The drill press 10 in the turned off mode thereof includes the motor 70 stopped.

The drill head 50 and the motor 70 and a platform 40 for bearing a workpiece are mounted on a column 30. The column 30 extends from a base 20. The base 20 enables the drill press 10 to stably rest on a surface. The column 30 lifts the drill head 50 and the motor 70 at a height. The column 30 lifts the platform 40 at a lower height than the drill head 50. The platform 40, the drill head 50 and the motor 70 on the column 30 are disposed above the base 20. The platform 40 is adjustably disposed on the column 30. The platform 40 includes a joint mechanism for adjustably engaging with the column 30. The column 30 includes a track 31 extending linearly and having a plurality of teeth for adjustably engaging with the joint mechanism. The joint mechanism includes a control handle. In the embodiment, the control handle is a crank 41. The crank 41 is turned in a first direction when raising the platform 40. The crank 41 is turned in a second direction, opposite to the first direction, when lowering the platform 40.

The drill press 10 also has a light 80. The light 80 allows a user of the drill press 10 to see better during processing the workpiece, but not limiting.

The drill press 10 in the turned on mode thereof and the drill head 50 in a position disengaging from the control 60 include the drill head 50 in a spinning motion and spins a bit when the bit is installed to the drill head 50. The drill press 10 in the turned on mode thereof and the drill head 50 in a position engaging with the control 60 include the drill head 50 in a stop and non-spin motion.

The drill head 50 in the position disengaging from the control 60 includes the depth adjusting mechanism 51 detaching from the switch 61.

The drill head 50 in the position engaging with the control 60 includes the depth adjusting mechanism 51 abutting against the switch 61.

In view of the forgoing, the drill press 10 of the present invention is energy-saving, safer, and allows a user to work efficiently because the drill head 50 engaging with the control 60 will not spin the bit installed thereto even though the drill press 10 is in the turned on mode thereof, and the drill head 50 in a lowering motion for processing a workpiece starts spinning the bit after it disengages from the control 60.

While the specific embodiments have been illustrated and described, numerous modifications come to mind without significantly departing from the spirit of invention, and the scope of invention is only limited by the scope of accompanying claims.

What is claimed is:

1. An energy-saving and safer drill press comprising:
a drill head having an original position and being operably moved from the original position in the process of a workpiece; and
a control selectively engaging with the drill head, and
wherein the drill press has a turned on and turn off modes, wherein the drill press in the turned on mode thereof and the drill head in a position disengaging from the control include the drill head in a spinning motion and spins a bit when the bit is installed to the drill head, and wherein the drill press in the turned on mode thereof and the drill head in a position engaging with the control include the drill head in a stop and non-spin motion.

2. The energy-saving and safer drill press as claimed in claim 1, wherein the drill head includes a motor cooperating therewith, with the motor driving the drill head to spin, with the drill press in the turned on mode thereof including the motor transmitting mechanical energy to the drill head, and with the drill press in the turned off mode thereof including the motor stopped.

3. The energy-saving and safer drill press as claimed in claim 1, wherein the control and the motor are electrically connected with each other.

4. The energy-saving and safer drill press as claimed in claim 3, wherein the drill head and the motor and a platform for bearing a workpiece are mounted on a column, with the column lifting the drill head and the motor at a height, and with the column lifting the platform at a lower height than the drill head.

5. The energy-saving and safer drill press as claimed in claim 4, wherein the column extends from a base, with the base enabling the drill press to stably rest on a surface, and with the platform, the drill head and the motor on the column disposed above the base.

6. The energy-saving and safer drill press as claimed in claim 3, wherein the control includes a switch and a depth adjusting mechanism that determines an allowable moving distance of the drill head selectively engages with the switch, with the drill head in the position disengaging from the control including the depth adjusting mechanism detaching from the switch, and with the drill head in the position engaging with the control including the depth adjusting mechanism abutting against the switch.

7. The energy-saving and safer drill press as claimed in claim 6, wherein the depth mechanism is equipped with the drill head, and wherein the depth mechanism includes a rod moving with the drill head and selectively engaging with the switch and includes a stopper adjustably disposed on and moving with the rod, and wherein the stopper abuts against a stop structure when the drill head is stopped.

8. The energy-saving and safer drill press as claimed in claim 7, wherein the rod and the stopper are threadly engaged with each other.

9. The energy-saving and safer drill press as claimed in claim 4, wherein the platform is adjustably disposed on the column, with the platform including a joint mechanism for adjustably engaging with the column.

10. The energy-saving and safer drill press as claimed in claim 9, wherein the joint mechanism includes a control handle.

11. The energy-saving and safer drill press as claimed in claim 9, wherein the control handle is a crank.

12. The energy-saving and safer drill press as claimed in claim 9, wherein the column includes a track extending linearly and having a plurality of teeth for adjustably engaging with the joint mechanism.
